(19) United States
(12) Patent Application Publication
(10) Pub. No.: US 2026/0187975 A1
(43) Pub. Date: Jul. 2, 2026

(54) METHOD AND APPARATUS FOR AGENT EXPLORATION BASED ON SIMILARITY SCORE OF TOPOLOGICAL GRAPH

(71) Applicant: Seoul National University R&DB Foundation, Seoul (KR)

(72) Inventors: Young Min KIM, Seoul (KR); Eun Sun LEE, Seoul (KR)

(21) Appl. No.: 19/217,656

(22) Filed: May 23, 2025

(30) Foreign Application Priority Data
Dec. 26, 2024 (KR) 10-2024-0197031

(51) Int. Cl. G06V 10/74; G06T 7/579; G06T 11/00; G06V 10/426; G06V 10/44

(52) U.S. Cl. CPC G06V 10/761; G06T 7/579; G06T 11/00; G06V 10/426; G06V 10/44

(57) ABSTRACT

An embodiment relates to a multi-agent exploration technique, and more particularly, to a technique of allowing each agent to plan an optimal exploration goal on the basis of similarity of a topological graph structure generated by the agent during multi-agent exploration. A method performed by an agent exploration apparatus operated by a processor according to one embodiment may comprise an operation of generating image information and location information of an exploration region in each search round; an operation of generating a first graph structure by setting image information of each search round as a first node, setting location information of each search round as a first edge, and connecting the first node of a current round to the first node of a previous round using the first edge; an operation of acquiring second node information of a second graph structure of each search round generated by another agent exploration device.

This work was supported by the National Research Foundation of Korea (NRF) grant funded by the Korea government (MSIT). (No. RS-2023-00208197)

### CROSS REFERENCE TO RELATED APPLICATION

The present application claims the benefit of Korean Patent No. 10-2024-0197031 filed in the Korean Intellectual Property Office on Dec. 26, 2024, the entire contents of which are incorporated herein by reference.

### BACKGROUND OF THE INVENTION

### Field of the Invention

The present invention relates to a multi-agent exploration technique, and more particularly, to a technique of allowing each agent to plan an optimal exploration goal on the basis of similarity of a topological graph structure generated by the agent during multi-agent exploration.

### Background of the Related Art

A multi-agent exploration technique is a technique that allows several autonomous robots to explore a specific environment or perform a task in cooperation, and it is one of important research fields in the fields of autonomous driving and artificial intelligence. The multi-agent exploration technique allows efficient exploration in a complex and wide environment, and shows high possibility of utilization in various industries such as logistics, manufacturing, construction, military, and space exploration. Unlike a single-agent system of independently exploring an environment by each robot, the multi-agent exploration technique may maximize resource utilization and work efficiency as a wider range can be explored simultaneously.

Meanwhile, existing multi-agent exploration techniques are generally divided into frontier-based exploration and reinforcement learning-based methods.

The frontier-based exploration supports efficient exploration by setting frontiers, i.e., boundaries between explored and unexplored regions, as a target. Although this method can be applied quickly using a simple algorithm, it has limitations in that exploration path collision or duplicate exploration may occur frequently in a complex environment, and it is difficult to adapt to dynamic environment changes.

In addition, the reinforcement learning-based method may learn the environment and plan an optimal exploration path in the long term, but it requires a large amount of data and a pre-learning process, and it is possible that the performance may be deteriorated in a new environment different from the learned environment.

In addition, in the multi-agent exploration technique, information sharing between agents has a great impact on the efficiency of exploration. In the existing techniques, information sharing between agents mainly uses a method of independently processing data by individual agents or collectively transmitting and processing all data in a central server. However, there is a high possibility that the method of independently processing data by individual agents generates exploration duplication due to lack of cooperation between the agents, and the method of collectively transmitting and processing all data in a central server may generate communication resource consumption and computational bottleneck due to data transmission and centralized processing.

To solve these problems, a new multi-agent exploration system requires efficient exploration goal setting, distributed information sharing, enhanced environmental adaptability, and data integrity and consistency.

To this end, the present invention proposes a method of effectively identifying unexplored regions and minimizing exploration duplication by combining frontier-based exploration and similarity score-based exploration.

### PRIOR ART DOCUMENT

### Patent Document

Korean Patent Registration No. 10-2735054

### Non-Patent Document

Devendra Singh Chaplot, Ruslan Salakhutdinov, Abhinav Gupta, and Saurabh Gupta. Neural topological slam for visual navigation. In Proceedings of the IEEE/CVF Conference on Computer Vision and Pattern Recognition, pages 12875-12884, 2020

### SUMMARY OF THE INVENTION

An object of the present invention is to provide a new method and system for overcoming the inefficiency and cooperation limitation that occur in multi-agent exploration. Although existing techniques are designed to set the boundary between an explored region and an unexplored region as an exploration goal or to learn an optimal exploration path through reinforcement learning, in a complex environment, problems such as duplication of exploration, difficulty in data integration, and lack of cooperation occur between the agents. In order to solve these problems, the present invention generates a topological graph using data collected by each agent during the exploration process, and generates a similarity score map on the basis of the graph to maximize exploration efficiency.

Particularly, the present invention allows each agent to set a global goal while sharing necessary data on the basis of a distributed structure without relying on a central server. Through this, the present invention may strengthen cooperation between the agents and prevent duplicate exploration while minimizing use of communication bandwidths.

In addition, as the present invention quantitatively calculates the similarity between nodes by utilizing a feature vector generated on the basis of RGBD image data, it is possible to accurately distinguish between explored and unexplored regions and allow the agent to efficiently set an exploration goal. This approach increases efficiency of exploration paths and provides flexibility of being adapted to various environmental changes in real time.

Through this, the present invention provides an exploration system that can enhance reliability of data accumulated during the exploration process, improve exploration efficiency, and stably operate even in a new environment.

Meanwhile, the technical problems of the present invention are not limited to the technical problems mentioned above, and unmentioned other technical problems can be clearly understood by those skilled in the art from the following description.

To accomplish the above objects, according to one aspect of the present invention, a method performed by an agent exploration apparatus operated by a processor may comprise: an operation of generating image information and location information of an exploration region in each search round; an operation of generating a first graph structure by setting image information of each search round as a first node, setting location information of each search round as a first edge, and connecting the first node of a current round to the first node of a previous round using the first edge; an operation of acquiring second node information of a second graph structure of each search round generated by another agent exploration device; an operation of calculating a similarity score between first node information and the second node information in each search round; an operation of mapping the similarity score of each search round to the first node of each search round of the first graph structure; and an operation of determining a search region of a next round on the basis of the similarity score mapped to the first node of the first graph structure.

In addition, the image information may include RGBD information captured in an exploration region of each search round.

In addition, the first node information may include a first feature vector in which the RGBD information is vectorized on the basis of a previously trained vision encoder.

In addition, the vision encoder may include an image encoder previously trained on the basis of a dataset of ImageNet.

In addition, the location information may include information on a relative location moved from an exploration region of the previous round to an exploration region of the current round.

In addition, the information on a relative location may include information on a relative change in an x-coordinate distance, a relative change in a y-coordinate distance, and a relative change in a rotation angle from the exploration region of the previous round to the exploration region of the current round.

In addition, another agent exploration apparatus performs: an operation of generating image information and moved location information of an exploration region in each search round; and an operation of generating a second graph structure by setting image information of each search round as a second node, setting location information of each search round as a second edge, and connecting the second node of a current round to the second node of a previous round using the second edge.

In addition, another agent exploration apparatus may include a plurality of agent exploration apparatuses.

In addition, the first node information may include a first feature vector in which the image information captured by the agent exploration device is vectorized, and the second node information may include a second feature vector in which the image information generated by a plurality of different agent exploration devices is vectorized.

In addition, the operation of calculating a similarity score may include an operation of calculating an inner product of the first feature vector of each search round and the second feature vector of each search round, and calculating a value obtained by adding up all inner product values generated in each search round as the similarity score of each search round.

In addition, the similarity score may be calculated on the basis of equation 1 shown below.

$${\sum }_{k = 1}^{d} {f}_{i}^{m} [ k ] \cdot {f}_{i}^{n} [ k ] \qquad [ Equation 1 ]$$

$$( {f}_{i}^{m}$$

is the first feature vector of the i-th search round,

$${f}_{i}^{n}$$

is the second feature vector of the i-th search round, k is an index representing an individual dimension of the feature vector, d is the number of dimensions of the feature vector, i is an index representing the search round, · is the inner product symbol, m is an index specifying an agent exploration apparatus, n is an index specifying another agent exploration apparatus, M is the number of all agent exploration apparatuses, and

$${\sum }_{n = 1}^{M}$$

is a symbol of adding up all inner product values generated in each search round).

In addition, the operation of mapping the similarity score may include: an operation of generating a map corresponding to the first graph structure on the basis of a Simultaneous Localization and Mapping (SLAM) technique; and an operation of mapping the similarity score to a location corresponding to each first node on the map.

In addition, the operation of determining a search region of a next round may include an operation of determining a search region of a next round on the basis of the similarity score mapped to a frontier region on the map.

In addition, the operation of determining a search region of a next round may include an operation of determining a region with a lowest similarity score mapped to the frontier region on the map as a search region of a next round.

In addition, the operation of determining a search region of a next round may include an operation of determining a search region of a next round on the basis of the similarity score mapped to the frontier region on the map and a weight of a distance to each frontier region.

In addition, the method may repeatedly perform operations from the operation of generating image information and moved location information to the operation of determining a search region of a next round until a preset condition is satisfied.

In addition, the preset condition may include a condition of performing the operations until the search round satisfies a predetermined number of times.

In addition, the preset condition may include a condition of performing the operations until the number of frontier regions on the map becomes smaller than or equal to a preset number.

An agent exploration apparatus according to an embodiment may comprise: a memory for storing instructions; and a processor for performing a predetermined operation on the basis of the instructions, wherein operations of the processor include: an operation of generating image information and location information of an exploration region in each search round; an operation of generating a first graph structure by setting image information of each search round as a first node, setting location information of each search round as a first edge, and connecting the first node of a current round to the first node of a previous round using the first edge; an operation of acquiring second node information of a second graph structure of each search round generated by another agent exploration device; an operation of calculating a similarity score between first node information and the second node information in each search round; an operation of mapping the similarity score of each search round to the first node of each search round of the first graph structure; and an operation of determining a search region of a next round on the basis of the similarity score mapped to the first node of the first graph structure.

A computer program stored in a computer-readable recording medium according to an embodiment and including instructions executed on at least one processor to perform, by the processor, an operation of generating image information and location information of an exploration region in each search round; an operation of generating a first graph structure by setting image information of each search round as a first node, setting location information of each search round as a first edge, and connecting the first node of a current round to the first node of a previous round using the first edge; an operation of acquiring second node information of a second graph structure of each search round generated by another agent exploration device; an operation of calculating a similarity score between first node information and the second node information in each search round; an operation of mapping the similarity score of each search round to the first node of each search round of the first graph structure; and an operation of determining a search region of a next round on the basis of the similarity score mapped to the first node of the first graph structure.

### BRIEF DESCRIPTION OF THE DRAWINGS

FIG. 1 is a view showing the configuration of an agent exploration apparatus according to an embodiment.

FIG. 2 is a flowchart illustrating the steps of the operation performed by an agent exploration apparatus according to an embodiment.

FIG. 3 is an exemplary view for explaining an operation of generating a graph structure by an agent exploration apparatus according to an embodiment.

FIG. 4 is an exemplary view for explaining an operation of calculating the similarity between first node information and second node information in each search round by an agent exploration apparatus according to an embodiment of the present invention.

FIG. 5 is an exemplary view for explaining an operation of mapping a similarity score of each search round to a first node in each search round of a first graph structure by an agent exploration apparatus according to an embodiment of the present invention.

FIG. 6 is an exemplary view for explaining an operation of generating a map using a first graph structure and a similarity score by an agent exploration apparatus according to an embodiment of the present invention.

FIG. 7 is an exemplary view for explaining an operation of determining a search region of a next round on the basis of a similarity score mapped to a frontier region by an agent exploration apparatus according to an embodiment of the present invention.

FIG. 8 is an exemplary view comparing results of explorations performed by applying existing techniques and the technique of the present invention under the same environmental conditions.

FIG. 9 is a performance comparison table comparing exploration efficiencies of existing techniques and the present invention according to the number of agent exploration apparatuses used for exploration.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments of the present invention will be described with reference to the accompanying drawings. However, it should be understood that this is not to limit the present invention to specific embodiments, but to include various modifications, equivalents, and/or alternatives of the embodiments of the present invention.

The present invention relates to a multi-agent exploration technique based on an autonomous robot, and more specifically, the present invention proposes an agent exploration apparatus 100 that implements a technique of allowing each agent to plan an optimal exploration goal on the basis of a topological graph structure between agents that determine an exploration region for generating a map of a specific space.

Hereinafter, the configuration of the agent exploration apparatus 100 of the present invention and the operation of each component will be described.

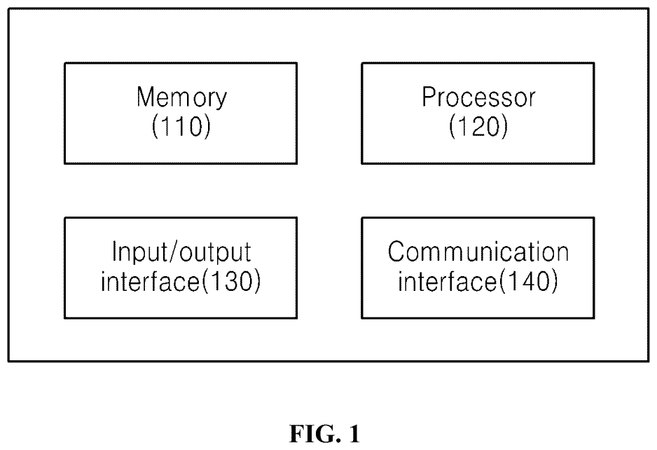

FIG. 1 is a view showing the configuration of an agent exploration apparatus 100 (hereinafter, referred to as an ‘apparatus 100’) according to an embodiment.

Referring to FIG. 1, the apparatus 100 according to an embodiment may each include a memory 110, a processor 120, an input/output interface 130, and a communication interface 140.

The memory 110 may store data acquired from an external device or data generated by itself. The memory 110 may store instructions that may perform operations of the processor 120. For example, the memory 110 may store RGBD images, location information, node information, edge information, graph structures, a previously trained vision encoder, SLAM algorithm code, and the like that appear in the following description.

The processor 120 is an arithmetic device that controls the overall operation. The processor 120 may execute the instructions stored in the memory 110. The operations of a user terminal 10 and the apparatus 100 according to an embodiment of this document may be understood as operations performed by the processor 120.

The input/output interface 130 may include a hardware interface or a software interface for inputting or outputting information.

The communication interface 140 allows information to be transmitted and received through a communication network. To this end, the communication interface 140 may include a wireless communication module or a wired communication module.

The apparatus 100 may be implemented as a variety of devices capable of performing operations through the processor 120 and transmitting and receiving information through a network. For example, the apparatus may be implemented in the form of a server, a computer device, a portable communication device, a smart phone, a portable multimedia device, a laptop computer, a tablet PC, or the like, but it is not limited to these examples.

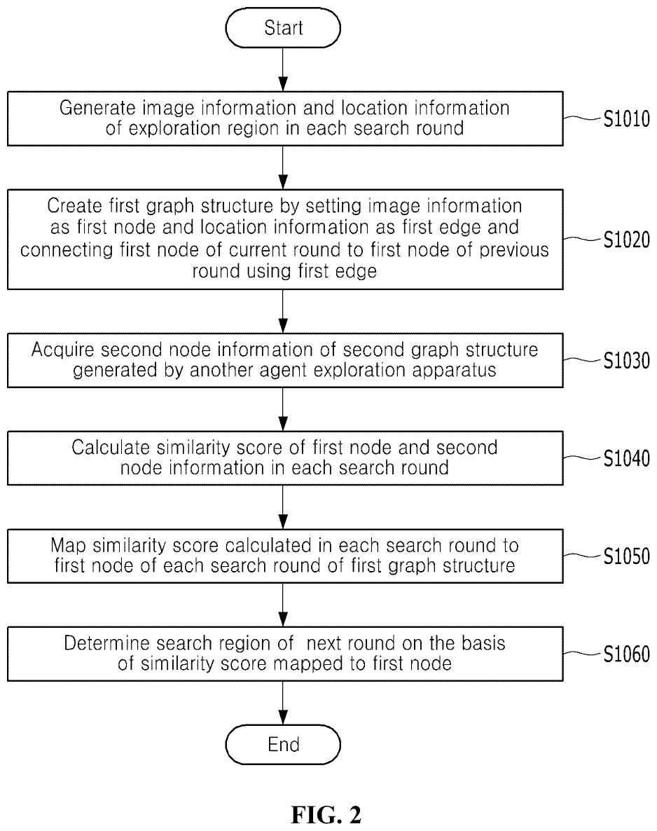

FIG. 2 is a flowchart illustrating operations performed by the apparatus 100 according to an embodiment. Specifically, FIG. 2 shows operations performed by each agent exploration apparatus in each search round to explore a specific space when a plurality of agent exploration apparatuses performs multi-agent exploration in a specific space. At this point, steps S1010 to S1060 may be repeatedly performed until a preset condition is completed, and one cycle from step S1010 to step S1060 will be referred to as a ‘search round’. Each agent exploration apparatus performs an operation of steps S1010 to S1060 according to the following description whenever a search round is performed.

Here, among a plurality of agent exploration apparatuses performing the multi-agent exploration, an agent exploration apparatus used as a reference for describing the operation of FIG. 2 is referred to as an ‘apparatus 100’. In addition, among a plurality of agent exploration apparatuses performing the multi-agent exploration, remaining agent exploration apparatuses excluding the ‘apparatus 100’ are referred to as ‘second apparatuses 101’. According to embodiments, the number of the second apparatuses 101 may be one or more, and when referring to any one or more among the remaining agent exploration apparatuses excluding the apparatus 100 used as a reference, they will be referred to as ‘second apparatuses 101’.

Meanwhile, each step disclosed in FIG. 2 is only a preferred embodiment for achieving the objects of the present invention, and some steps may be added or deleted as needed, and one step may be included in another step to be executed. The order of each operation disclosed in FIG. 2 is only an order arranged for convenience of understanding, and this order is not limited to a time-series order, and may be changed to operate in a different order according to the choice of a designer.

At step S1010, the apparatus 100 may generate image information and location information of an exploration region in each search round.

The image information of S1010 may include visual data collected by the apparatus 100 in an exploration region.

For example, the image information may include RGBD information captured in an exploration region of each search round. The RGBD information means data that combines RGB images (Red, Green, Blue color information) and D images (depth images). Among the RGBD information, the RGB image provides visual features such as the color and texture of an exploration region and the D image provides depth information in pixel units so that the distance and location of an object can be identified. The RGBD information plays an important role in constructing an accurate spatial model of an explored region, and planning an exploration path or setting an exploration goal.

The location information of S1010 may include data indicating spatial changes as the apparatus 100 moves during a specific exploration round.

For example, the location information may include information on the relative location that is changed while moving from an exploration region of a previous search round to the exploration region of the current search round. For example, information on the relative location may include information on the relative change in the x-coordinate distance, the relative change in the y-coordinate distance, and the relative change in the rotation angle while the apparatus 100 moves from an exploration region of a previous search round to the exploration region of the current search round.

In addition, at step S1010, when the search round is a first round, the apparatus 100 generates image information of the initially located region, and since there is no relative movement in the first round, a null value may be generated as the location information. In addition, when the search round is a second round or higher, the apparatus 100 may move to a determined exploration region and generate image information of the exploration region, and generates a change in the relative location due to the movement from a previous exploration region to the current exploration region as the location information.

As described above, the image information and location information generated at step S1010 are used as basic data for understanding the structure of an environment explored according to the operation described below and planning a next exploration route.

At step S1020, the apparatus 100 may set image information of each search round as nodes and set location information of each search round as edges, and generate a graph structure connecting the nodes generated in the current round to the nodes generated in the previous round using the edges. The apparatus 100 may update the graph structure by generating new nodes and edges in each search round and connecting the new nodes and edges to the nodes generated in a previous round.

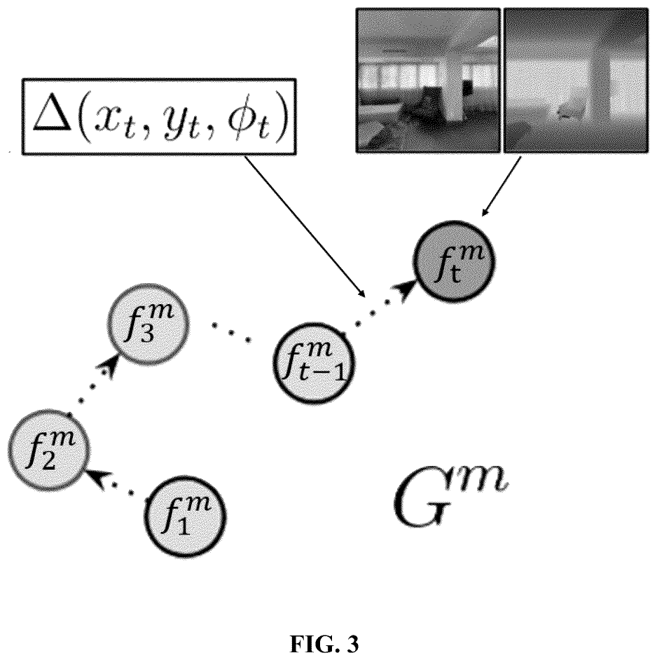

FIG. 3 is an exemplary view for explaining an operation of generating a graph structure by the apparatus 100 according to an embodiment of the present invention.

Referring to FIG. 3, the graph structure is a topological data structure for efficiently expressing the spatial relationship and visual information of exploration regions, and may be configured of nodes and edges as shown in FIG. 3.

For example, a node may include a feature vector generated on the basis of image information. For example, the apparatus 100 may convert RGBD data explored in the t-th round into a high-dimensional feature vector by using a previously trained vision encoder, and set the feature vector as a node

$${f}_{t}^{m}$$

corresponding to the t-th round. The vision encoder may use various image vector generation models. At this point, the vision encoder may use an image encoder previously trained on the basis of the dataset of ImageNet. For example, the vision encoder may be previously trained on the basis of paper “Junnan Li, Pan Zhou, Caiming Xiong, and Steven CH Hoi. Prototypical contrastive learning of unsupervised representations. arXiv preprint arXiv: 2005.04966, 2020.”

For example, an edge may include information on the relative location between an exploration region of a previous round and the exploration region of the current round. The information on the relative location may include information on the distance and direction moved. For example, the edge may include information on the relative change in the x-coordinate distance, the relative change in the y-coordinate distance, and the relative change in the rotation angle Δ(xₜ, yₜ, Øₜ) as the apparatus 100 moves from the exploration region of the t−1-th round to the exploration region of the t-th round.

Accordingly, the apparatus 100 may create a first graph structure G^{m} by connecting the node

$${f}_{t}^{m}$$

generated in the t-th round of the current round to the first node

$${f}_{t - 1}^{m}$$

generated in the t−1-th round of the previous round using the first edge generated in the t-th round.

At step S1030, the apparatus 100 may acquire node information of a graph structure generated in each search round by another agent exploration apparatus (hereinafter, referred to as a ‘second apparatus 101’) participating in the multi-agent exploration. That is, like the apparatus 100, each second apparatus 101 performs steps S1010 to S1060, and at step S1030 among the steps, node information of the graph structure generated or updated in each search round is shared with each other.

Hereinafter, in order to distinguish between the graph structure generated by the apparatus 100 and the graph structure generated by the second apparatus 101, the graph structure generated by the first apparatus 100 is referred to as a ‘first graph structure’, the node included in the first graph structure is referred to as a ‘first node’, and the edge included in the first graph structure is referred to as a ‘first edge’. At this point, the feature vector included in the first node is referred to as a ‘first feature vector’.

In addition, the graph structure generated by the second apparatus 101 is referred to as a ‘second graph node’, the node included in the second graph structure is referred to as a ‘second node’, and the edge included in the second graph structure is referred to as a ‘second edge’. At this point, the feature vector included in the second node is referred to as a ‘second feature vector’.

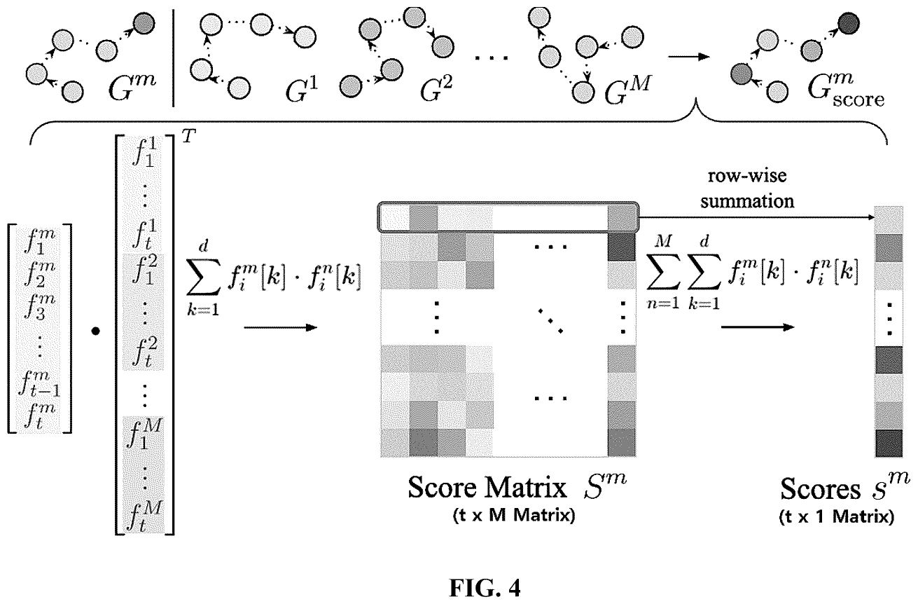

At step S1040, the apparatus 100 may calculate a similarity score between its own first node information in each search round and second node information of the second apparatus 101 in each search round. A specific embodiment of step S1040 is described with reference to FIG. 4.

FIG. 4 is an exemplary view for explaining an operation of calculating the similarity between first node information and second node information in each search round by the apparatus 100 according to an embodiment of the present invention.

Referring to FIG. 4, the apparatus 100 may calculate the similarity through the inner product of the first feature vector included in the first node information of each search round and the second feature vector included in the second node information of each search round.

For example, the device 100 may calculate the inner product of the first feature vector of each search round and the second feature vector of each search round on the basis of equation 1 shown below.

$${\sum }_{k = 1}^{d} {f}_{i}^{m} [ k ] \cdot {f}_{i}^{n} [ k ] \qquad [ Equation 1 ]$$

$${f}_{i}^{m}$$

is the first feature vector of the i-th search round,

$${f}_{i}^{n}$$

is the second feature vector of the i-th search round, k is an index representing an individual dimension of the feature vector, d is the number of dimensions of the feature vector, i is an index representing the search round, · is the inner product symbol, m is an index specifying an agent exploration apparatus 100, and n is an index specifying another agent exploration apparatus 101.

Accordingly, the apparatus 100 may calculate a value obtained by adding up all inner product values generated in each search round as the similarity score of each search round on the basis of equation 2 shown below.

$${\sum }_{n = 1}^{M} {\sum }_{k = 1}^{d} {f}_{i}^{m} [ k ] \cdot {f}_{i}^{n} [ k ] \qquad [ Equation 2 ]$$

(n is an index specifying another agent exploration apparatus 101, Mis the number of all agent exploration apparatuses, and

$${\sum }_{n = 1}^{M}$$

is a symbol for adding up the inner product values in each search round calculated through equation 1 described above)

In order to explain details of the equation described above with reference to FIG. 4, it is assumed that the number of agent exploration apparatuses participating in the multi-agent exploration is M. First, according to equation 1, the apparatus 100 corresponding to the m-th agent exploration apparatus among the M agent exploration apparatuses may generate a matrix S^{m} configured in a size of t×M as shown in FIG. 4 by performing equation 1 on the first to M-th agent exploration apparatuses including the apparatus 100 itself.

Next, according to equation 2, the apparatus 100 may generate a final matrix S^{m} configured in a size of t×1 by adding up the scores in each row of matrix S^{m} of a size of t×M. At this point, each row of the final matrix S^{m} of a size of t×1 includes similarity scores between the apparatus 100 and all remaining second apparatuses 101 calculated in each search round.

At this point, the similarity score is a key index representing the similarity of exploration data between the apparatus 100 and all remaining second apparatuses 101 in each search round, and is used to determine a next exploration region by confirming how much the data explored in a specific exploration round overlaps in the operation described below.

For example, a higher similarity score calculated in a specific round indicates that the visual and spatial characteristics of the region explored in that round are similar to those of the regions explored by other agents. On the contrary, a lower similarity score calculated in a specific round indicates that the explored region is a region relatively less explored. Accordingly, the similarity score is used as an important criterion for minimizing exploration duplication and efficiently identifying unexplored regions.

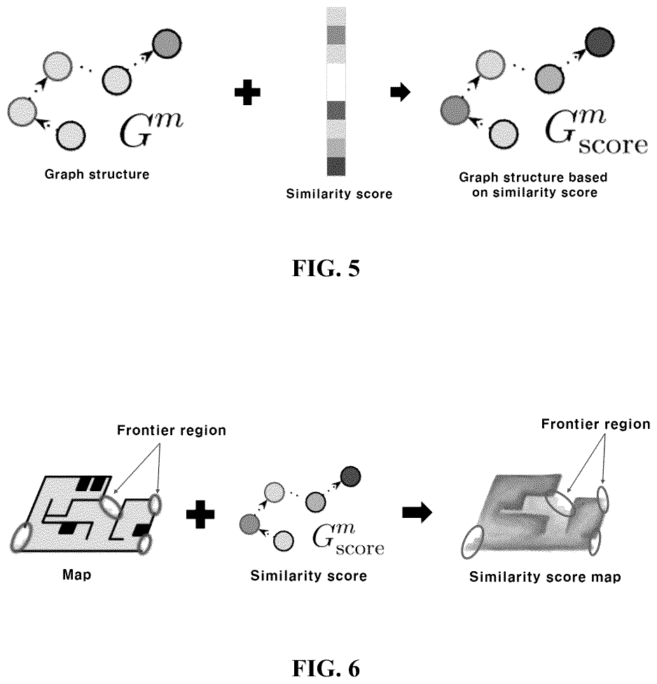

At step S1050, the apparatus 100 may map the similarity score calculated in each search round to the first node of each search round of the first graph structure. A specific embodiment of step S1050 is described with reference to FIG. 5.

FIG. 5 is an exemplary view for explaining an operation of mapping a similarity score of each search round to a first node in each search round of a first graph structure by an apparatus 100 according to an embodiment of the present invention.

Referring to FIG. 5, the apparatus 100 may generate a graph structure based on similarity score by mapping the similarity score between the apparatus 100 and all remaining second apparatuses 101 calculated in each search round (e.g., 1, 2, 3, . . . , m−1, m) to the first node of each search round (e.g., 1, 2, 3, . . . , m−1, m) among the first graph structure generated at step S1020.

At this point, the graph structure based on similarity score includes similarity score data indicating exploration duplication and possibility of identifying unexplored regions for each node, in addition to the information of existing nodes and edges. At this point, the similarity score mapped to each node means that the higher the score, the higher the possibility of an exploration region for being duplicated, and the lower the score, it is more likely that the node is an unexplored region.

In addition, at step S1050, the apparatus 100 may generate a map that can visually distinguish an exploration region on the basis of the first graph structure and the similarity score. This embodiment is described with reference to FIG. 6.

FIG. 6 is an exemplary view for explaining an operation of generating a map using a first graph structure and a similarity score by an apparatus 100 according to an embodiment of the present invention.

Referring to FIG. 6, the apparatus 100 may generate a map corresponding to the first graph structure on the basis of the Simultaneous Localization and Mapping (SLAM) technique. The technique of generating a map from a graph structure using the SLAM technique may utilize various known techniques such as Graph-based SLAM or the like. In this case, frontier regions, i.e., boundaries between explored and unexplored regions, may be detected in the generated map. The frontier regions are used as an important criterion for setting a target region that the agent exploration apparatus should explore next.

Meanwhile, since it is possible that the frontier region detected in the map generated as described above is a region already explored by another agent device, the present invention may determine the priority of frontier regions to be explored by utilizing the similarity score as follows.

Referring to FIG. 6, the apparatus 100 may generate a similarity score map that maps the similarity score of each search round to a location corresponding to a first node in each search round on the generated map. For convenience of understanding, the similarity score map shown in FIG. 6 expresses high and low of the similarity score in each region of the map as high and low of red saturation. That is, the higher the red saturation, the higher the similarity score, which means it is highly likely that the region has been explored, and the lower the red saturation, the lower the similarity score, which means it is highly likely that the region has not been explored.

Accordingly, the apparatus 100 may confirm reliability of the exploration state at each exploration point through a similarity score map that visually maps the similarity score calculated in each search round onto the generated map.

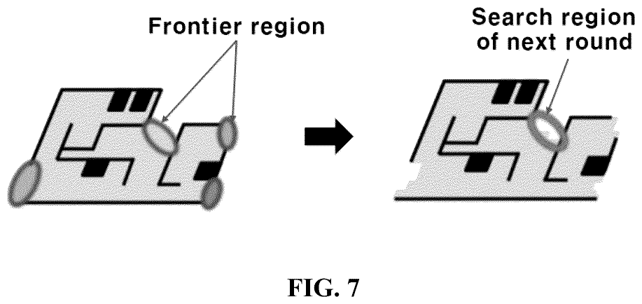

At step S1060, the apparatus 100 may determine a search region of the next round on the basis of the similarity score mapped to the first node. For example, when the similarity score map of FIG. 6 is generated, the apparatus 100 may determine the search region of the next round on the basis of the similarity score mapped to the frontier region on the generated map. A specific embodiment of step S1060 will be described with reference to FIG. 7.

FIG. 7 is an exemplary view for explaining an operation of determining a search region of a next round on the basis of a similarity score mapped to a frontier region by the apparatus 100 according to an embodiment of the present invention.

Referring to the figure on the left side in FIG. 7, a similarity score is mapped to each frontier region. There are four frontier regions in the figure on the left side in FIG. 7, and the apparatus 100 may determine a region with the lowest mapped similarity score among the four frontier regions (e.g., the region with the lowest red saturation) as the search region of the next round.

Meanwhile, when a next search is determined based only on the similarity score, inefficiency in the search distance may occur when a frontier region at a distance relatively far from the current location of the apparatus 100 is set as the search region of the next round. In this case, when the distance that the apparatus 100 should move is greater than a predetermined threshold, the apparatus 100 may determine the search region of the next round on the basis of the similarity score mapped to each frontier region and the weight of the distance to each frontier region. For example, the weight may be set such that the farther the location of a specific frontier region is from the current location of the apparatus 100, the lower the probability of selecting the frontier region to search.

Meanwhile, the final map may be completed by setting steps S1010 to S1060 described above to be repeatedly performed until a preset condition is satisfied. For example, the preset condition may include a condition of repeatedly performing steps S1010 to S1060 until the search round satisfies a predetermined number of times (e.g., 10 times) or a condition of repeatedly performing until the number of frontier regions of the map generated at step S1050 becomes lower than or equal to a preset number (e.g., 1).

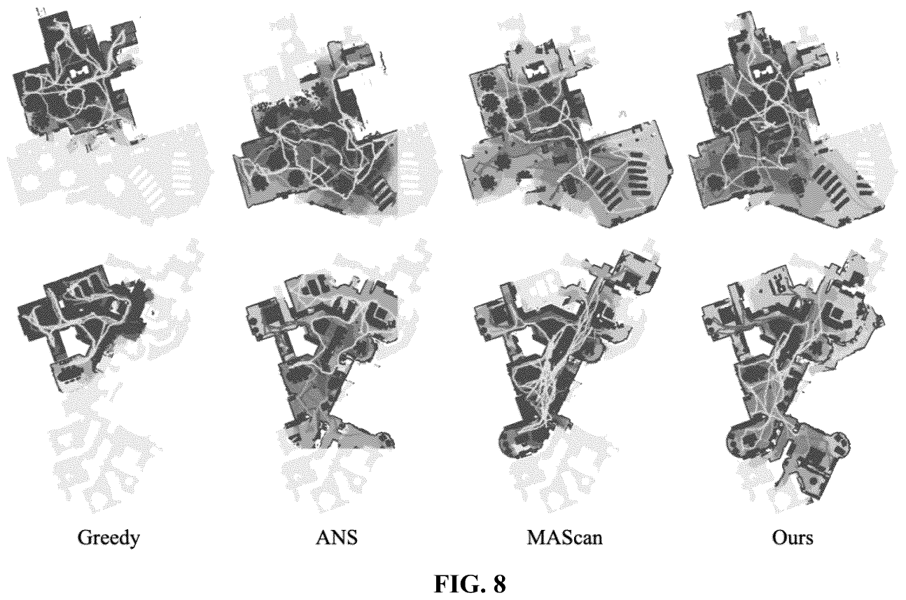

FIG. 8 is an exemplary view comparing results of explorations performed by applying existing techniques and the technique of the present invention under the same environmental conditions. Each figure shown in FIG. 8 visually shows the degree of overlapped exploration paths and distribution of unexplored regions.

Referring to FIG. 8, the Greedy method shows that there are many unexplored regions since the exploration paths are inefficiently overlapped. In addition, although the ANS and MAScan methods increase efficiency by reducing overlapping of exploration paths, there are still unexplored regions, and optimization of the paths is insufficient. In contrast thereto, as the method of the present invention (Ours) sets an exploration goal on the basis of similarity scores and frontier regions according to the proposed algorithm, it can be seen that overlapping of the exploration paths is minimized, and unexplored regions are effectively covered. This shows that the present invention is superior to existing methods from the aspect of exploration efficiency and resource utilization.

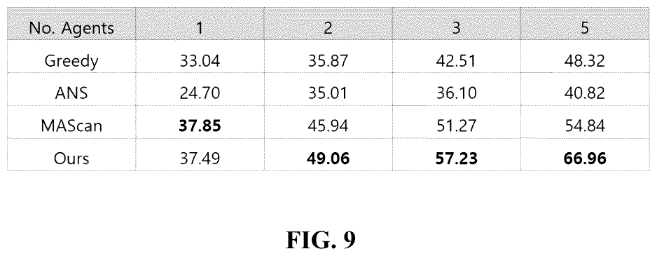

FIG. 9 is a performance comparison table comparing exploration efficiencies of existing techniques and the present invention according to the number of agent exploration apparatuses used for exploration. The values included in the table of FIG. 9 are indexes that quantitatively evaluate exploration efficiency, and a higher value means that more regions are explored efficiently.

Referring to FIG. 9, the method of the present invention (Ours) achieves the highest efficiency when the number of agents is two or more, and particularly, it can be confirmed that increase in the exploration performance is dramatically improved as the number of agents increases. On the other hand, improvement in performance of the existing Greedy and ANS algorithms is limited even when the number of agents increases, and although MAScan shows an excellent result at a specific number of agents, the overall efficiency is lower than that of the method of the present invention. Through this, it can be confirmed that the method of the present invention is superior from the aspect of cooperation between agents and utilization of exploration resources.

According to the embodiment described above, as the present invention provides a technique that greatly improves efficiency and cooperation in multi-agent exploration, there is an effect of overcoming limitations of existing techniques and increasing accuracy and adaptability of exploration.

Specifically, the present invention may minimize exploration duplication and optimize exploration paths by precisely analyzing exploration data in a way of utilizing feature vectors extracted from RGBD image data and calculating a similarity between the nodes. In addition, it is possible to efficiently identify unexplored regions and distribute the exploration goal without conflict between the agents by combining frontier-based exploration and similarity score-based exploration. Through this, the multi-agent system may maintain high efficiency and precision even in a wide and complex environment.

In addition, the present invention may clearly distinguish between explored and unexplored regions and maximize exploration efficiency while preventing duplicate exploration by introducing a topological graph and a similarity score map for cooperative exploration between agents. Through this, the present invention may contribute to minimizing use of communication bandwidths and increase scalability of the system by setting exploration goals in real time on the basis of data collected by each agent and reducing dependence on a central server through a distributed data sharing structure.

Accordingly, the present invention may provide a basic technique for stably and effectively utilizing autonomous robots in various industrial fields by realizing all of efficient exploration goal setting, distributed data processing, global consistency assurance, and environmental adaptability in a multi-agent exploration system. This makes dramatic improvement in exploration efficiency, precision, and system scalability possible compared to existing techniques.

Various embodiments of this document and terms used herein are not intended to limit the technical features described in this document to specific embodiments, and should be understood to include various changes, equivalents, or substitutes of a corresponding embodiment. In relation to the description of drawings, similar reference numerals may be used for similar or related components. The singular form of a noun corresponding to an item may include one or a plurality of item unless a related context clearly dictates otherwise.

In this document, each of phrases such as “A or B”, “at least one among A and B”, “at least one among A and B”, “A, B or C”, “at least one among A, B and/or C”, “at least one among A, B or C” may include all possible combinations of items listed together in a corresponding phrase among the phrases. Terms such as “a first”, “a second”, “the first”, “the second”, and the like may be used simply to distinguish a corresponding component from another and do not limit corresponding components in different aspects (e.g., importance or sequence). When a certain component (e.g., a first component) is mentioned to be “coupled” or “connected” to another component (e.g., a second component) with or without a term such as “functionally” or “communicatively”, this means that the certain component may be connected to another component directly (e.g., wiredly), wirelessly, or through a third component.

The term “module” used in this document may include units implemented in hardware, software, or firmware, and may be used interchangeably with the terms such as logic, logic blocks, parts, circuits, or the like. The module may be an integrated part, a minimum unit of a part that performs one or more functions, or a part thereof. For example, according to an embodiment, the module may be implemented in the form of an application-specific integrated circuit (ASIC).

Various embodiments of this document may be implemented as software (e.g., program) including one or more instructions stored in a storage medium (e.g., memory) that can be read by a device (e.g., electronic device). The storage medium may include random access memory (RAM), memory buffers, hard drives, databases, erasable programmable read-only memory (EPROM), electrically erasable read-only memory (EEPROM), read-only memory (ROM), and/or the like.

In addition, a processor in the embodiments of this document may call at least one instruction among one or more stored instructions from a storage medium and execute the instruction. This allows the device to be operated to perform at least one function according to the at least one instruction that is called. These one or more instructions may include a code generated by a compiler or a code that can be executed by an interpreter. The processor may be a general-purpose processor, a field programmable gate array (FPGA), an application specific integrated circuit (ASIC), a digital signal processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish between a case where data is stored semi-permanently in the storage medium and a case where data is stored temporarily.

Methods according to various embodiments disclosed in this document may be provided to be included in a computer program product. Computer program products are goods and may be traded between sellers and buyers. The computer program product may be distributed in the form of a storage medium that can be read by a device (e.g., compact disc read only memory (CD-ROM)) or may be distributed (e.g., downloaded or uploaded) through an application store (e.g., Play Store) or directly online between two user devices (e.g., smart phones). In the case of online distribution, at least some of computer program products may be at least temporarily stored or temporarily created in a storage medium that can be read by a device, such as a manufacturer's server, an application store's server, or a server's memory.

According to various embodiments, each component (e.g., module or program) among the components described above may include a single entity or a plurality of entities. According to various embodiments, one or more of the components or operations described above may be omitted, or one or more other components or operations may be added. In substitution or addition, a plurality of components (e.g., modules or programs) may be integrated into a single component. In this case, the integrated component may perform one or more functions of each of the plurality of components in a manner the same as or similar to those performed by a corresponding component of the plurality of components prior to integration. According to various embodiments, the operations performed by the modules, programs, or other components may be executed sequentially, in parallel, iteratively, or heuristically, or one or more of the operations may be executed in a different order or omitted, or one or more other operations may be added.

As the present invention provides a technique that greatly improves efficiency and cooperation in multi-agent exploration, there is an effect of overcoming limitations of existing techniques and increasing accuracy and adaptability of exploration.

Specifically, the present invention may minimize exploration duplication and optimize exploration paths by precisely analyzing exploration data in a way of utilizing feature vectors extracted from RGBD image data and calculating a similarity between the nodes. In addition, it is possible to efficiently identify unexplored regions and distribute the exploration goal without conflict between the agents by combining frontier-based exploration and similarity score-based exploration. Through this, the multi-agent system may maintain high efficiency and precision even in a wide and complex environment.

In addition, the present invention may clearly distinguish between explored and unexplored regions and maximize exploration efficiency while preventing duplicate exploration by introducing a topological graph and a similarity score map for cooperative exploration between agents. Through this, the present invention may contribute to minimizing use of communication bandwidths and increase scalability of the system by setting exploration goals in real time on the basis of data collected by each agent and reducing dependence on a central server through a distributed data sharing structure.

Accordingly, the present invention may provide a basic technique for stably and effectively utilizing autonomous robots in various industrial fields by realizing all of efficient exploration goal setting, distributed data processing, global consistency assurance, and environmental adaptability in a multi-agent exploration system. This makes dramatic improvement in exploration efficiency, precision, and system scalability possible compared to existing techniques.

Meanwhile, the effects of the present invention are not limited to those mentioned above, and unmentioned other technical effects will be clearly understood by those skilled in the art from the following description.

### DESCRIPTION OF SYMBOLS

100: Apparatus
101: Second apparatus
110: Memory
120: Processor
130: Input/Output interface
140: Communication interface

What is claimed is:

1. A method performed by an agent exploration apparatus operated by a processor, the method comprising:
an operation of generating image information and location information of an exploration region in each search round;
an operation of generating a first graph structure by setting image information of each search round as a first node, setting location information of each search round as a first edge, and connecting the first node of a current round to the first node of a previous round using the first edge;
an operation of acquiring second node information of a second graph structure of each search round generated by another agent exploration device;
an operation of calculating a similarity score between first node information and the second node information in each search round;
an operation of mapping the similarity score of each search round to the first node of each search round of the first graph structure; and
an operation of determining a search region of a next round on the basis of the similarity score mapped to the first node of the first graph structure.

2. The method according to claim 1, wherein the image information includes RGBD information captured in an exploration region of each search round.

3. The method according to claim 2, wherein the first node information includes a first feature vector in which the RGBD information is vectorized on the basis of a previously trained vision encoder.

4. The method according to claim 3, wherein the vision encoder includes an image encoder previously trained on the basis of a dataset of ImageNet.

5. The method according to claim 1, wherein the location information includes information on a relative location moved from an exploration region of the previous round to an exploration region of the current round.

6. The method according to claim 5, wherein the information on a relative location includes information on a relative change in an x-coordinate distance, a relative change in a y-coordinate distance, and a relative change in a rotation angle from the exploration region of the previous round to the exploration region of the current round.

7. The method according to claim 1, wherein another agent exploration apparatus performs:
an operation of generating image information and moved location information of an exploration region in each search round; and
an operation of generating a second graph structure by setting image information of each search round as a second node, setting location information of each search round as a second edge, and connecting the second node of a current round to the second node of a previous round using the second edge.

8. The method according to claim 1, wherein another agent exploration apparatus includes a plurality of agent exploration apparatuses.

9. The method according to claim 8, wherein the first node information includes a first feature vector in which the image information captured by the agent exploration device is vectorized, and the second node information includes a second feature vector in which the image information generated by a plurality of different agent exploration devices is vectorized.

10. The method according to claim 9, wherein the operation of calculating a similarity score includes an operation of calculating an inner product of the first feature vector of each search round and the second feature vector of each search round, and calculating a value obtained by adding up all inner product values generated in each search round as the similarity score of each search round.

11. The method according to claim 10, wherein the similarity score is calculated on the basis of equation 1 shown below,
$${\sum }_{k = 1}^{d} {f}_{i}^{m} [ k ] \cdot {f}_{i}^{n} [ k ] \qquad [ Equation 1 ]$$
$$( {f}_{i}^{m}$$
is the first feature vector of an i-th search round,
$${f}_{i}^{n}$$
is the second feature vector of the i-th search round, k is an index representing an individual dimension of the feature vector, dis the number of dimensions of the feature vector, i is an index representing the search round, · is an inner product symbol, m is an index specifying an agent exploration apparatus, n is an index specifying another agent exploration apparatus, M is the number of all agent exploration apparatuses, and
$${\sum }_{n = 1}^{M}$$
is a symbol of adding up all inner product values generated in each search round).

12. The method according to claim 1, wherein the operation of mapping the similarity score includes:
an operation of generating a map corresponding to the first graph structure on the basis of a Simultaneous Localization and Mapping (SLAM) technique; and
an operation of mapping the similarity score to a location corresponding to each first node on the map.

13. The method according to claim 12, wherein the operation of determining a search region of a next round includes an operation of determining a search region of a next round on the basis of the similarity score mapped to a frontier region on the map.

14. The method according to claim 13, wherein the operation of determining a search region of a next round includes an operation of determining a region with a lowest similarity score mapped to the frontier region on the map as a search region of a next round.

15. The method according to claim 13, wherein the operation of determining a search region of a next round includes an operation of determining a search region of a next round on the basis of the similarity score mapped to the frontier region on the map and a weight of a distance to each frontier region.

16. The method according to claim 1, repeatedly performing operations from the operation of generating image information and moved location information to the operation of determining a search region of a next round until a preset condition is satisfied.

17. The method according to claim 16, wherein the preset condition includes a condition of performing the operations until the search round satisfies a predetermined number of times.

18. The method according to claim 17, wherein the preset condition includes a condition of performing the operations until the number of frontier regions on the map becomes smaller than or equal to a preset number.

19. An agent exploration apparatus comprising:
a memory for storing instructions; and
a processor for performing a predetermined operation on the basis of the instructions, wherein
operations of the processor include:
an operation of generating image information and location information of an exploration region in each search round;
an operation of generating a first graph structure by setting image information of each search round as a first node, setting location information of each search round as a first edge, and connecting the first node of a current round to the first node of a previous round using the first edge;
an operation of acquiring second node information of a second graph structure of each search round generated by another agent exploration device;
an operation of calculating a similarity score between first node information and the second node information in each search round;
an operation of mapping the similarity score of each search round to the first node of each search round of the first graph structure; and
an operation of determining a search region of a next round on the basis of the similarity score mapped to the first node of the first graph structure.

20. A computer program stored in a computer-readable recording medium and including instructions executed on at least one processor to perform, by the processor,
an operation of generating image information and location information of an exploration region in each search round;
an operation of generating a first graph structure by setting image information of each search round as a first node, setting location information of each search round as a first edge, and connecting the first node of a current round to the first node of a previous round using the first edge;
an operation of acquiring second node information of a second graph structure of each search round generated by another agent exploration device;
an operation of calculating a similarity score between first node information and the second node information in each search round;
an operation of mapping the similarity score of each search round to the first node of each search round of the first graph structure; and
an operation of determining a search region of a next round on the basis of the similarity score mapped to the first node of the first graph structure.
